(19) United States
(12) Patent Application Publication
(10) Pub. No.: US 2009/0080062 A1
(43) Pub. Date: Mar. 26, 2009

(54) METHOD FOR PREPARING A POLED STRUCTURE BY USING DOUBLE-SIDED ELECTRODES

(75) Inventors: Shang Ling Liu, Hsinchu (TW); Tso Lun Wu, Hsinchu (TW); Tze Chia Lin, Hsinchu (TW); Ming Hsien Chou, Hsinchu (TW)

Correspondence Address: CONNOLLY BOVE LODGE & HUTZ LLP, 1875 EYE STREET, N.W., SUITE 1100, WASHINGTON, DC, 20006, US

(73) Assignee: HC PHOTONICS CORP., Hsinchu (TW)

(21) Appl. No.: 11/861,874

(22) Filed: Sep. 26, 2007

(51) Int. Cl. G02F 1/35

(52) U.S. Cl. 359/326; 264/435

(57) ABSTRACT

A method for preparing a poled structure by using double-sided electrodes to perform a poling process first provides a ferroelectric substrate with a first polarization direction having a top surface and a bottom surface. Fabrication processes are then performed to form an electrode structure including a first electrode and a second electrode on the top surface and a third electrode in a portion of the bottom surface between the first electrode and the second electrode. Subsequently, a poling process is performed on the electrode structure to form a plurality of inverted domains having a second polarization direction in the ferroelectric substrate, and the second polarization direction is substantially opposite to the first polarization direction.

### BACKGROUND OF THE INVENTION

(A) Field of the Invention

The present invention relates to a method for preparing a poled structure, and more particularly, to a method for preparing a poled structure by using double-sided electrodes to perform a poling process.

(B) Description of the Related Art

The poled structure having poled domains in a ferroelectric single crystal such as lithium niobate (LiNbO₃), lithium tantalite (LiTaO₃) and potassium titanyl phosphate (KTiOPO₄) may be widely used in the optical fields such as optical storage and optical measurement. There are several methods for preparing the poled structure such as the proton-exchanging method, the electron beam-scanning method, the electric voltage applying method, etc.

U.S. Pat. No. 6,002,515 discloses a method for manufacturing a polarization inversion part on a ferroelectric crystal substrate. The polarization inversion part is prepared by steps of applying a voltage in the polarization direction of the ferroelectric crystal substrate to form a polarization inversion part, conducting a heat treatment for reducing an internal electric field generated in the substrate by the applied voltage, and then reinverting polarization in a part of the polarization inversion part by applying a reverse direction voltage against the voltage that was previously applied. In other words, the method for preparing a polarization inversion part disclosed in U.S. Pat. No. 6,002,515 requires performing the application of electric voltage twice.

U.S. Pat. No. 6,353,495 discloses a method for forming an optical waveguide element. The disclosed method forms a convex ridge portion having a concave portion on a ferroelectric single crystalline substrate, and a ferroelectric single crystalline film is then formed in the concave portion. A comb-shaped electrode and a uniform electrode are formed on a main surface of the ferroelectric single crystalline substrate, and electric voltage is applied to these two electrodes to form a ferroelectric domain-inverted structure in the film in the concave portion.

### SUMMARY OF THE INVENTION

One aspect of the present invention provides a method for preparing a poled structure by using double-sided electrodes to perform a poling process.

A method for preparing a poled structure according to this aspect of the present invention first provides a ferroelectric substrate with a first polarization direction having a top surface and a bottom surface. Fabrication processes are then performed to form an electrode structure including a first electrode and a second electrode on the top surface and a third electrode in a portion of the bottom surface between the first electrode and the second electrode. Subsequently, a poling process is performed on the electrode structure to form a plurality of inverted domains having a second polarization direction in the ferroelectric substrate, and the second polarization direction is substantially opposite to the first polarization direction.

Compared with the prior art, the present invention can prepare the poled structure with the inverted domains having desired width and depth. In addition, the present invention provides a poling technique for preparing the poled structure with the inverted domains having the desired width and depth by changing the shapes and the arrangements of the electrode structure.

### BRIEF DESCRIPTION OF THE DRAWINGS

The objectives and advantages of the present invention will become apparent upon reading the following description and upon reference to the accompanying drawings in which:

FIG. 1 to FIG. 3 illustrate a method for preparing a poled structure according to one embodiment of the present invention;

FIG. 4 to FIG. 6 show the shapes of the electrodes according to one embodiment of the present invention;

FIG. 7(A) to FIG. 7(I) show several designs of the electrode structure according to one embodiment of the present invention;

FIG. 8 shows the electric field distributions by applying the same voltages to these electrode designs according to one embodiment of the present invention;

FIG. 9(A) to FIG. 9(C) show several designs of the electrode structure according to the present invention; and FIG. 10(A) to FIG. 10(C) show several designs of the electrode structure according to the present invention.

### DETAILED DESCRIPTION OF THE INVENTION

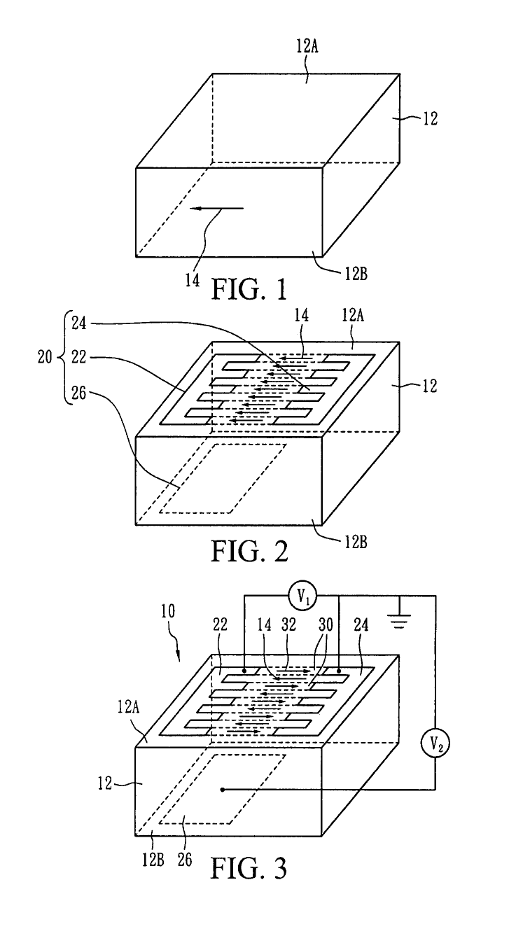

FIG. 1 to FIG. 3 illustrate a method for preparing a poled structure 10 according to one embodiment of the present invention. The method first provides a ferroelectric substrate 12 with a first polarization direction 14 having a top surface 12A and a bottom surface 12B. Fabrication processes, such as metal deposition and etching processes, are then performed to form an electrode structure 20 including a first electrode 22 and a second electrode 24 on the top surface 12A and a third electrode 26 in a portion of the bottom surface 12B between the first electrode 22 and the second electrode 22, as shown in FIG. 2.

Referring to FIG. 3, a poling process is performed on the electrode structure 20 to form a plurality of inverted domains 30 having a second polarization direction 32 in the ferroelectric substrate 12, and the second polarization direction 32 is substantially opposite to the first polarization direction 14. In particular, the poling process is performed by applying a first voltage to the first electrode 22, a second voltage to the second electrode 24 and a third voltage to the third electrode 26. Preferably, the first voltage is higher than the second voltage, the first voltage is higher than the third voltage, and the third voltage is higher than the second voltage.

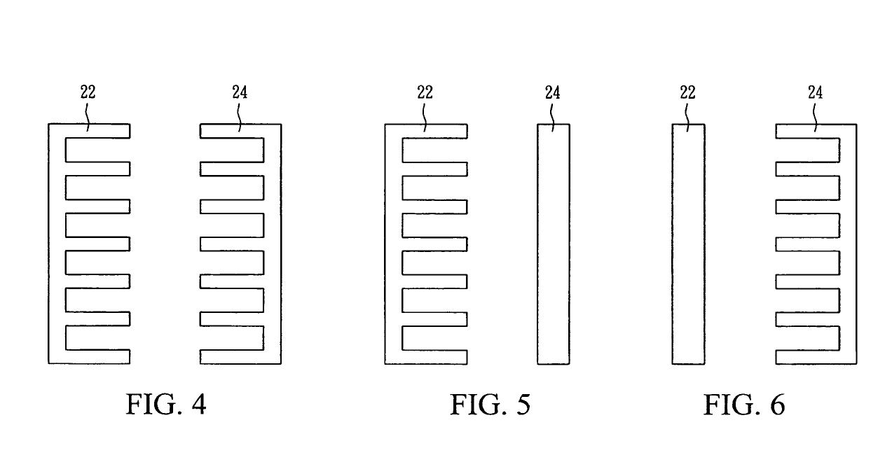

FIG. 4 to FIG. 6 show the shapes of the electrodes according to one embodiment of the present invention. Preferably, the first electrode 22 and the second electrode 24 are comb-shaped, as shown in FIG. 4. In addition, the first electrode 22 and the second electrode 24 may have different shapes, for example, the first electrode 22 is comb-shaped and the second electrode 24 is linear, or vice versa, as shown in FIG. 5 and FIG. 6, respectively.

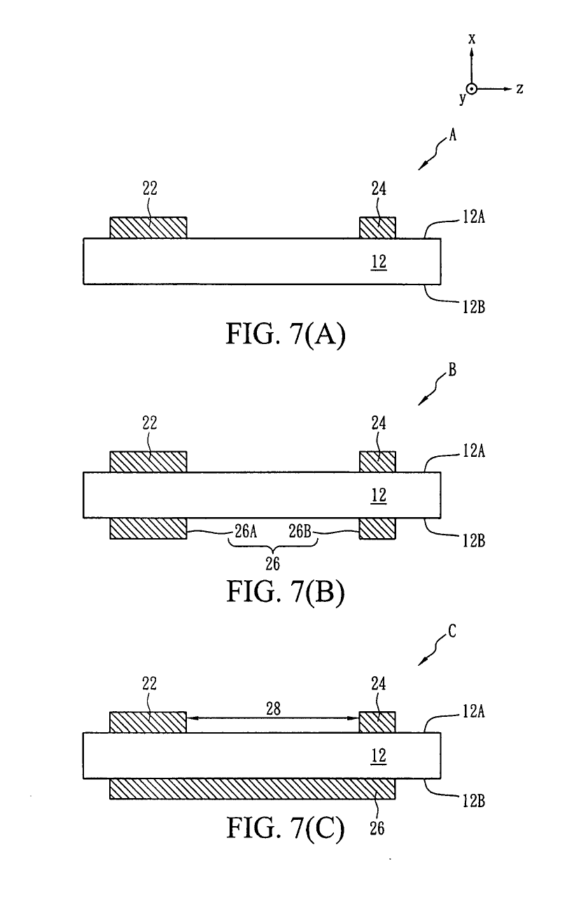

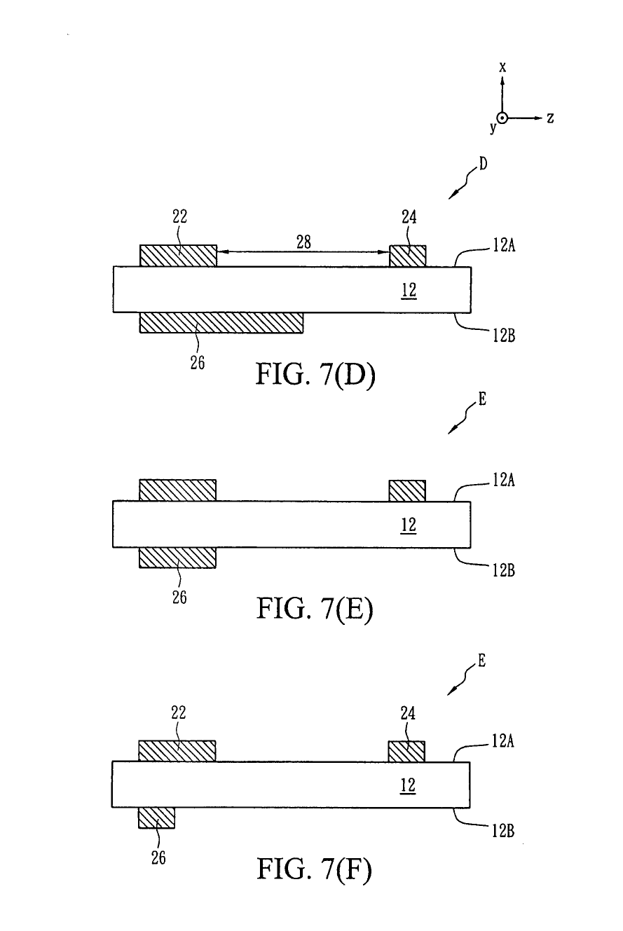

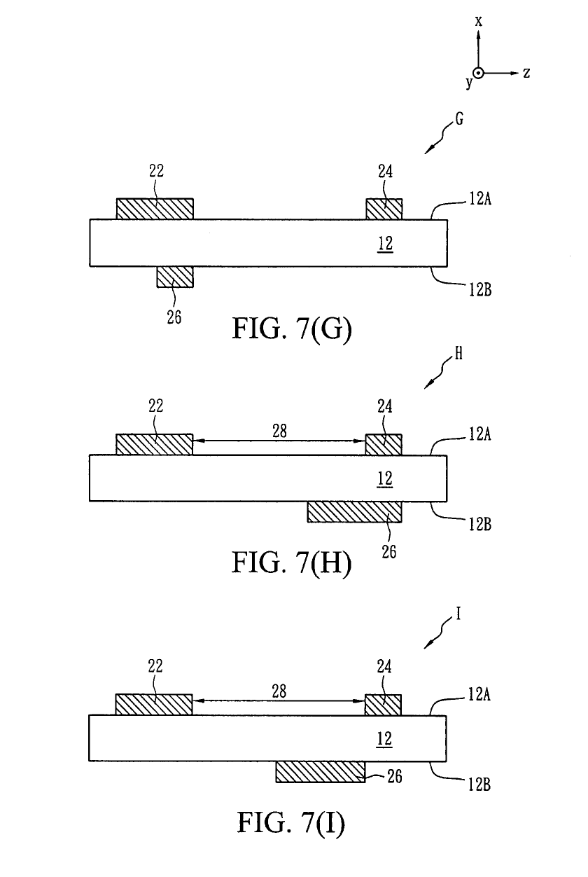

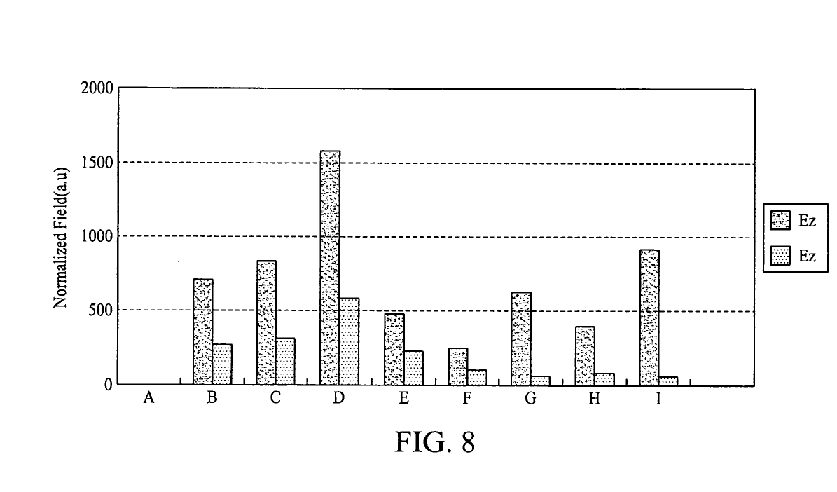

FIG. 7(A) to FIG. 7(I) show several designs of the electrode structure 20, and FIG. 8 shows the electric field distributions by applying the same voltages to these electrode designs according to the present invention. In particular, the electric field strength of the electrode designs B-I are normalized with respect to that of the electrode design A in FIG. 7(A), i.e., the strength of the electric field generated in the ferroelectric substrate 12 by using the electrode design A is set to be one.

Referring to the electrode design B in FIG. 7(B), the third electrode 26 includes a first block 26A positioned right below the first electrode 22 and a second block 26B positioned right below the second electrode 24, and the corresponding electric field generated in the ferroelectric substrate 12 has an electric field increased by 661 times in the z-direction and 250 times in the x-direction, as compared with the electrode design A in FIG. 7(A).

Referring to the electrode design C in FIG. 7(C), the first electrode 22 and the second electrode 24 are separated by a poling area 28, and the third electrode 26 covers a portion of the bottom surface 12B corresponding to the first electrode 22, the second electrode 24 and the poling area 28. The corresponding electric field generated in the ferroelectric substrate 12 has an electric field increased by 786 times in the z-direction and 286 times in the x-direction, as compared with the electrode design A in FIG. 7(A).

Referring to the electrode design D in FIG. 7(D), the first electrode 22 and the second electrode 24 are separated by the poling area 28, and the third electrode 26 covers a portion of the bottom surface 12B corresponding to the first electrode 22 and a portion of the poling area 28. The corresponding electric field generated in the ferroelectric substrate 12 has an electric field increased by 1570 times in the z-direction and 536 times in the x-direction, as compared with the electrode design A in FIG. 7(A).

Referring to the electrode design E in FIG. 7(E), the width of the third electrode 26 is the same as that of the first electrode 22. The corresponding electric field generated in the ferroelectric substrate 12 has an electric field increased by 464 times in the z-direction and 214 times in the x-direction, as compared with the electrode design A in FIG. 7(A).

Referring to the electrode design F in FIG. 7(F), the third electrode 26 covers a portion of the bottom surface 12B corresponding to a left portion of the first electrode 22. The corresponding electric field generated in the ferroelectric substrate 12 has an electric field increased by 232 times in the z-direction and 89 times in the x-direction, as compared with the electrode design A in FIG. 7(A).

Referring to the electrode design G in FIG. 7(G), the third electrode 26 covers a portion of the bottom surface 12B corresponding to a right portion of the first electrode 22. The corresponding electric field generated in the ferroelectric substrate 12 has an electric field increased by 598 times in the z-direction and 53 times in the x-direction, as compared with the electrode design A in FIG. 7(A).

Referring to the electrode design H in FIG. 7(H), the first electrode 22 and the second electrode 24 are separated by the poling area 28, and the third electrode 26 covers a portion of the bottom surface 12B corresponding to the second electrode 24 and a portion of the poling area 28. The corresponding electric field generated in the ferroelectric substrate 12 has an electric field increased by 375 times in the z-direction and 71 times in the x-direction, as compared with the electrode design A in FIG. 7(A).

Referring to the electrode design I in FIG. 7(I), the first electrode 22 and the second electrode 24 are separated by the poling area, and third electrode 26 covers a portion of the bottom surface 12B corresponding to a portion of the poling area 28. The corresponding electric field generated in the ferroelectric substrate 12 has an electric field increased by 893 times in the z-direction and 50 times in the x-direction, as compared with the electrode design A in FIG. 7(A).

It is clear that various electrode designs shown in FIG. 7(B) to FIG. 7(I) can be used to generate different electric field distribution of increased strength in the ferroelectric substrate 12 by applying the same voltages to these electrodes. In particular, the increased electric field in the z-direction can be used to prepare the inverted domains 30 having an increased width, and the increased electric field in the x-direction can be used to prepare the inverted domains 30 having an increased depth. Consequently, the present invention provides a poling technique for preparing the poled structure 10 with the inverted domains 30 having the desired width and depth by changing the shapes and the arrangements of the electrode structure 20.

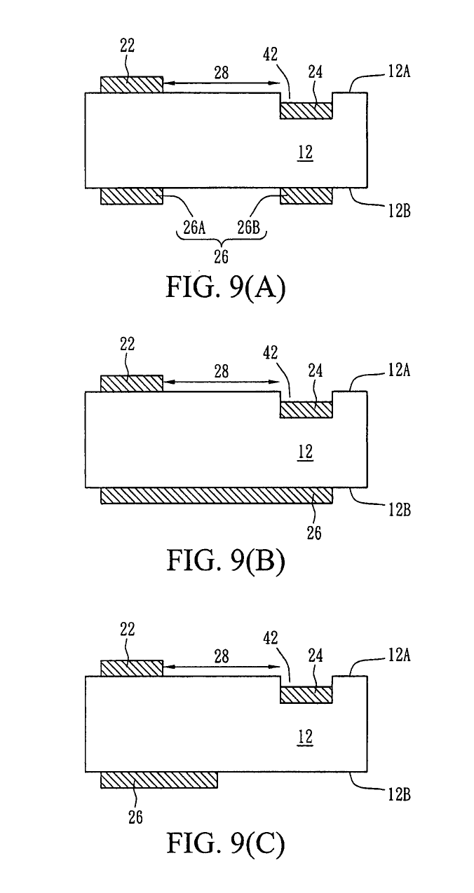

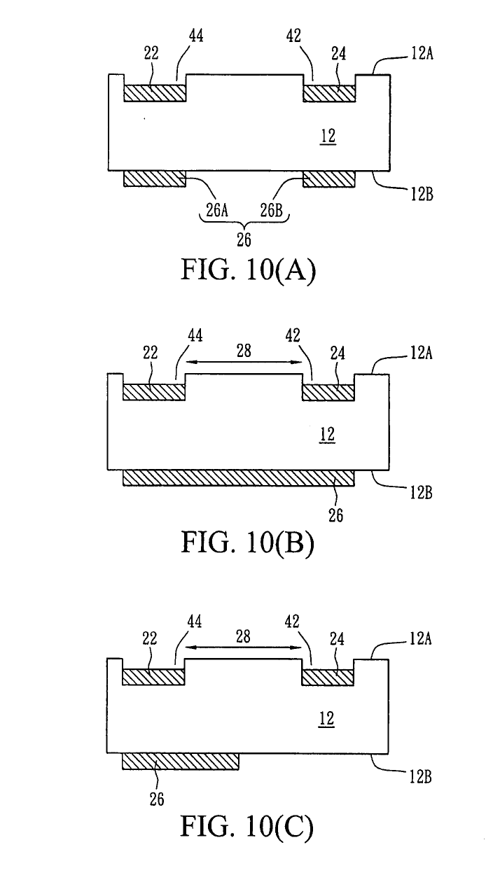

FIG. 9(A) to FIG. 9(C) show several designs of the electrode structure 20 according to the present invention. The formation of the electrode structure 20 may include a step of forming a trench 42 on the top surface 12A, and the second electrode 24 is then formed in the trench 42. In particular, the third electrode 26 may include a first block 26A positioned right below the first electrode 22 and a second block 26B positioned right below the trench 42, as shown in FIG. 9(A).

Referring to FIG. 9(B), the first electrode 22 and the trench 42 are separated by the poling area 28, and the third electrode 26 may cover a portion of the bottom surface 12B corresponding to the first electrode 22, the trench 42 and the poling area 28. In addition, the first electrode 22 and the second electrode 24 are separated by the poling area 28, and the third electrode 26 may cover a portion of the bottom surface 12B corresponding to the first electrode 22 and a portion of the poling area 28, as shown in FIG. 9 (C).

FIG. 10(A) to FIG. 10(C) show several designs of the electrode structure 20 according to the present invention. The formation of the electrode structure 20 may include a step of forming a trench 42 and a trench 44 on the top surface 12A, the first electrode 22 is formed in the trench 44, and the second electrode 24 is formed in the trench 42. The third electrode 26 may include a first block 26A positioned right below the trench 44 and a second block 26B positioned right below the second trench 42, as shown in FIG. 10(A).

Referring to FIG. 10(B), the first trench 44 and the second trench 42 are separated by the poling area 28, and the third electrode 26 covers a portion of the bottom surface 12B corresponding to the first trench 44, the second trench 42 and the poling area 28. In addition, the first trench 44 and the second trench 42 are separated by the poling area, and the third electrode 26 may cover a portion of the bottom surface 12B corresponding to the first trench 44 and a portion of the poling area 28, as shown in FIG. 10(C).

Compared with the prior art, the present invention can prepare the poled structure 10 with inverted domains 30 having increased width and depth. In addition, the present invention provides a poling technique to prepare the poled structure 10 with the inverted domains 30 having the desired width and depth by changing the shapes and the arrangements of the electrode structure 20.

The above-described embodiments of the present invention are intended to be illustrative only. Numerous alternative embodiments may be devised by those skilled in the art without departing from the scope of the following claims.

What is claimed is:

1. A method for preparing a poled structure, comprising the steps of:
providing a ferroelectric substrate with a first polarization direction the ferroelectric substrate having a top surface and a bottom surface;
forming an electrode structure including a first electrode and a second electrode on the top surface and a third electrode in a portion of the bottom surface between the first electrode and the second electrode; and
performing a poling process on the electrode structure to form a plurality of inverted domains having a second polarization direction in the ferroelectric substrate, and the second polarization direction being substantially opposite to the first polarization direction.

2. The method for preparing a poled structure as claimed in claim 1, wherein the first electrode and the second electrode have different shapes.

3. The method for preparing a poled structure as claimed in claim 1, wherein the first electrode is comb-shaped and the second electrode is linear.

4. The method for preparing a poled structure as claimed in claim 1, wherein the first electrode and the second electrode are comb-shaped.

5. The method for preparing a poled structure as claimed in claim 1, wherein the poling process is performed by applying a first voltage to the first electrode, a second voltage to the second electrode and a third voltage to the third electrode.

6. The method for preparing a poled structure as claimed in claim 5, wherein the first voltage is higher than the second voltage.

7. The method for preparing a poled structure as claimed in claim 5, wherein the first voltage is higher than the third voltage.

8. The method for preparing a poled structure as claimed in claim 1, wherein the third electrode includes a first block positioned right below the first electrode and a second block positioned right below the second electrode.

9. The method for preparing a poled structure as claimed in claim 1, wherein the first electrode and the second electrode are separated by a poling area, and the third electrode covers a portion of the bottom surface corresponding to the first electrode, the second electrode and the poling area.

10. The method for preparing a poled structure as claimed in claim 1, wherein the first electrode and the second electrode are separated by a poling area, and the third electrode covers a portion of the bottom surface corresponding to the first electrode and a portion of the poling area.

11. The method for preparing a poled structure as claimed in claim 1, wherein the width of the third electrode is the same as that of the first electrode.

12. The method for preparing a poled structure as claimed in claim 1, wherein the third electrode covers a portion of the bottom surface corresponding to a left portion of the first electrode.

13. The method for preparing a poled structure as claimed in claim 1, wherein the third electrode covers a portion of the bottom surface corresponding to a right portion of the first electrode.

14. The method for preparing a poled structure as claimed in claim 1, wherein the first electrode and the second electrode are separated by a poling area, and the third electrode covers a portion of the bottom surface corresponding to the second electrode and a portion of the poling area.

15. The method for preparing a poled structure as claimed in claim 1, wherein the first electrode and the second electrode are separated by a poling area, and third electrode covers a portion of the bottom surface corresponding to a portion of the poling area.

16. The method for preparing a poled structure as claimed in claim 1, wherein the step of forming an electrode structure includes forming a trench on the top surface, and the second electrode is formed in the trench.

17. The method for preparing a poled structure as claimed in claim 16, wherein the third electrode includes a first block positioned right below the first electrode and a second block positioned right below the trench.

18. The method for preparing a poled structure as claimed in claim 16, wherein the first electrode and the trench are separated by a poling area, and the third electrode covers a portion of the bottom surface corresponding to the first electrode, the trench and the poling area.

19. The method for preparing a poled structure as claimed in claim 16, wherein the first electrode and the second electrode are separated by a poling area, and the third electrode covers a portion of the bottom surface corresponding to the first electrode and a portion of the poling area.

20. The method for preparing a poled structure as claimed in claim 1, wherein the step of forming an electrode structure includes forming a first trench and a second trench on the top surface, the first electrode is formed in the first trench, and the second electrode is formed in the second trench.

21. The method for preparing a poled structure as claimed in claim 20, wherein the third electrode includes a first block positioned right below the first trench and a second block positioned right below the second trench.

22. The method for preparing a poled structure as claimed in claim 20, wherein the first trench and the second trench are separated by a poling area, and the third electrode covers a portion of the bottom surface corresponding to the first trench, the second trench and the poling area.

23. The method for preparing a poled structure as claimed in claim 20, wherein the first trench and the second trench are separated by a poling area, and the third electrode covers a portion of the bottom surface corresponding to the first trench and a portion of the poling area.
